(19) United States
(12) Patent Application Publication
(10) Pub. No.: US 2015/0338430 A1
(43) Pub. Date: Nov. 26, 2015

(54) EXCESSIVE VEHICLE ACCELERATION DETECTION USING A MOBILE DEVICE

(71) Applicant: Regents of the University of Minnesota, Minneapolis, MN (US)

(72) Inventors: Alec Gorjestani, Rosemount, MN (US); Edmund P. Arpin, St. Paul, MN (US); Arvind Menon, Minneapolis, MN (US); Janet Creaser, Minneapolis, MN (US); Christopher J. Edwards, Hugo, MN (US); Nichole L. Morris, St. Paul, MN (US); Michael Manser, Minneapolis, MN (US); Max Donath, Minneapolis, MN (US)

(21) Appl. No.: 14/718,782

(22) Filed: May 21, 2015

Related U.S. Application Data
(60) Provisional application No. 62/001,601, filed on May 21, 2014.

(51) Int. Cl. G01P 15/00

(52) U.S. Cl. CPC G01P 15/00

(57) ABSTRACT

Techniques are described for measuring acceleration of a vehicle with a mobile device. The techniques are applied to detect excessive acceleration events of the vehicle. The techniques are implemented in a mobile device that includes an accelerometer, a global positioning system (GPS) sensor, and a processor configured to identify an excessive acceleration event of a vehicle that the mobile device is located in. The processor is configured to receive, from the accelerometer, a first acceleration data when the vehicle is a rest and a second acceleration data when the vehicle is moving. The processor is also configured to determine, based on the first acceleration data, a gravity vector, and determine, based on the second acceleration data, an acceleration vector for the mobile device. The processor is further configured to, responsive to determining that a y-coordinate axis of the acceleration vector for the mobile device is aligned with the gravity vector: update the acceleration vector by removing the gravity vector from the acceleration vector for the mobile device, and process the updated acceleration vector to identify the excessive acceleration event for the vehicle.

The application claims the benefit of U.S. Provisional Application No. 62/001,601, filed May 21, 2014, the contents of which are incorporated by reference herein in their entirety.

### TECHNICAL FIELD

The disclosure describes acceleration measurements and, in particular, acceleration measurements of vehicles.

### BACKGROUND

Excessive acceleration of a vehicle may often be indicative of reckless or high-risk driving behavior. However, accurately monitoring acceleration of a vehicle is often difficult. For example, conventional vehicles do not typically include or otherwise provide an inertial measurement unit (IMU) that is readily accessible for measuring and monitoring the acceleration of the vehicle. Moreover, many normal high-acceleration events, such as driving over speed bumps and potholes, are a common occurrence while driving a vehicle on the roadway and make it difficult to accurately identify abnormal, excessive acceleration events of interest.

### SUMMARY

In some examples, the disclosure describes a method that includes receiving, from an accelerometer in a mobile device within a vehicle, a first acceleration data when the vehicle is at rest and a second acceleration data when the vehicle is moving. The method includes determining, based on the first acceleration data, a gravity vector. The method includes determining, based on the second acceleration data, an acceleration vector for the mobile device. The method further includes, responsive to determining that a y-coordinate axis of the acceleration vector for the mobile device is aligned with the gravity vector: updating the acceleration vector by removing the gravity vector from the acceleration vector for the mobile device; and processing the updated acceleration vector to identify an excessive acceleration event for the vehicle.

In some examples, the disclosure describes a device including an accelerometer, a global positioning system (GPS) sensor, and a processor configured to identify an excessive acceleration event of a vehicle that the mobile device is located in. The processor is configured to receive, from the accelerometer, a first acceleration data when the vehicle is a rest and a second acceleration data when the vehicle is moving. The processor is also configured to determine, based on the first acceleration data, a gravity vector, and determine, based on the second acceleration data, an acceleration vector for the mobile device. The processor is further configured to, responsive to determining that a y-coordinate axis of the acceleration vector for the mobile device is aligned with the gravity vector: update the acceleration vector by removing the gravity vector from the acceleration vector for the mobile device, and process the updated acceleration vector to identify the excessive acceleration event for the vehicle.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual diagram illustrating an example acceleration monitoring environment in which a mobile device applies the techniques described herein to more accurately determine the acceleration of a vehicle.

FIG. 2 is a block diagram illustrating one example of a mobile device implementing the techniques described herein.

FIG. 3 is a flow diagram illustrating one example of an acceleration monitoring application implementing the techniques described herein.

FIG. 4 is a flow diagram illustrating one example of an acceleration monitoring application implementing the techniques described herein.

FIG. 5 is a flow diagram illustrating one example of an acceleration monitoring application implementing the techniques described herein.

### DETAILED DESCRIPTION

The present disclosure describes techniques for measuring acceleration with a mobile device. For example, techniques are described for measuring acceleration with a plurality of different types of instruments (e.g., a global positioning system (GPS) and an accelerometer) within a mobile device. The individual instruments may not accurately reflect the true acceleration of a vehicle. The techniques described in the present disclosure may provide a more accurate measurement of the vehicle acceleration. In some examples, the techniques may be applied to detect excessive or extreme maneuvers of the vehicle. That is, the techniques may more accurately detect excessive acceleration events and, therefore, provide information indicative of heightened risks for the vehicle and occupants. Moreover, the techniques described herein may mitigate false positives that may otherwise be induced by normal high-acceleration events, such as drive over speed bumps and potholes, while providing a high accuracy and sensitivity for identifying excessive acceleration events.

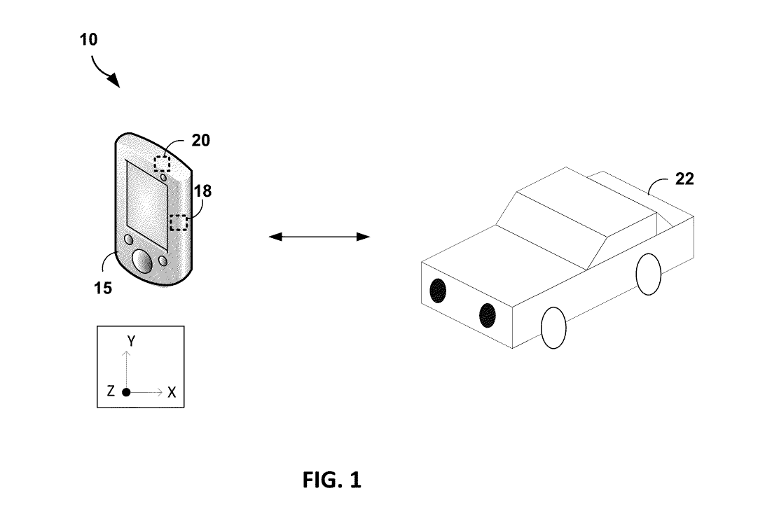

FIG. 1 is a conceptual diagram illustrating an example acceleration monitoring environment 10 in which a mobile device applies the techniques described herein to more accurately determine the acceleration of a vehicle. In the example of FIG. 1, environment 10 includes a mobile device 15 and a vehicle 22. Vehicle 22 includes any type of motor vehicle, such as a car, truck, semi-trailer, bus, etc.

In the example of FIG. 1, mobile device 15 is illustrated as a mobile phone. However, in other examples, mobile device 15 includes a tablet computer, a personal digital assistant (PDA), a laptop computer, a media player, an e-book reader, a wearable computing device (e.g., a watch, eyewear), or any other type of mobile or non-mobile computing device suitable for performing the techniques described herein.

Mobile device 15 provides an execution environment for one or more software applications that, as described, determines the acceleration of vehicle 22 based on multiple sensors of different types (e.g., a GPS and an accelerometer) included in mobile device 15.

In the example implementation, mobile device 15 includes GPS 18 and inertial measurement unit (IMU) 20. In addition, although not shown in FIG. 1, mobile device 15 includes one or more processors, microprocessors, internal memory and/or data storage and other electronic circuitry for executing software or firmware to provide the functionality described herein.

In some examples, by combining acceleration information from multiple sensors of different types, mobile device 15 more accurately detects excessive vehicle acceleration. GPS 18 and IMU 20 provide information about acceleration of vehicle 22 that are used to determine whether an excessive acceleration event has occurred. Mobile device 15 reduces false positives by determining whether both GPS 18 and IMU 20 indicate that an excessive acceleration event has occurred.

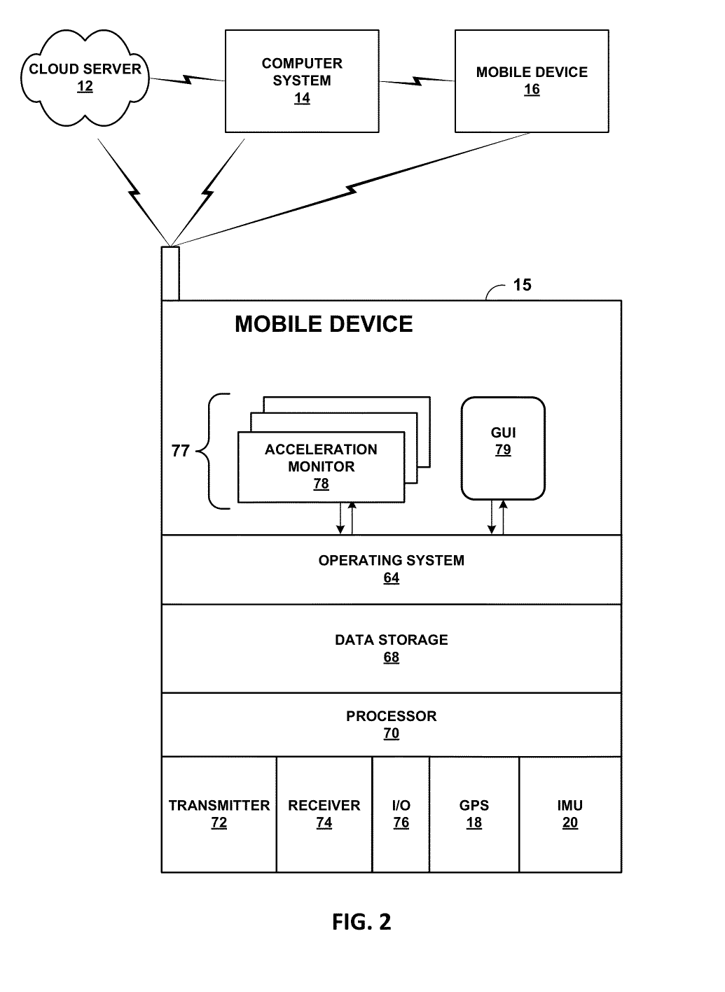

FIG. 2 illustrates a block diagram illustrating an example of a mobile device implementing the techniques described herein. For purposes of example, the mobile device of FIG. 2 will be described with respect to mobile device 15 of FIG. 1.

Mobile device 15 includes various hardware components that provide core functionality for operation of the device. For example, mobile device 15 includes one or more programmable processors 70 configured to operate according to executable instructions (i.e., program code), typically stored in a computer-readable medium or data storage 68 such as static, random-access memory (SRAM) device or flash memory device. I/O 76 includes one or more devices, such as a keyboard, camera button, power button, volume button, home button, back button, menu button, touchscreen, or other input or output device. Transmitter 72 and receiver 74 provide wireless communication with other devices, such as cloud server 12, computer system 14, or other mobile device 16, via a wireless communication. For example, transmitter 72 outputs, and receiver 74 receives, data via WiFi, radio frequency (RF) signals, cellular networks (e.g., GSM, CDMA, LTE, etc), or other wireless communication medium.

In some examples, GPS 18 monitors and records the location, speed, and acceleration of mobile device 15 over time. IMU 20 includes an accelerometer that monitors and records the acceleration and gravitational forces of mobile device 15. IMU 20 may include additional components, such as a gyroscope, that monitor and record the velocity and orientation of mobile device 15. In some examples, mobile device 15 includes additional discrete digital logic or analog circuitry not shown in FIG. 2.

In general, operating system 64 executes on processor 70 and provides an operating environment for one or more user applications 77 (commonly referred to “apps”), including acceleration monitoring application 78. In some examples, user applications 77 comprise executable program code stored in computer-readable storage device (e.g., data storage 68) for execution by processor 70. As other examples, user applications 77 comprise firmware or, in some examples, are implemented in discrete logic. User applications 77 invoke kernel functions of operating system 64. For example, operating system 64 outputs a graphical user interface (GUI) 79 for presenting information to a user of mobile device.

Acceleration monitoring application 78 receives data from GPS 18 and IMU 20. Acceleration monitoring application 78 monitors acceleration using the data received from GPS 18 and IMU 20. Acceleration monitoring application determines whether an excessive acceleration event has occurred, updates GUI 79 to present a notification of excessive acceleration to a user, and sends information about an excessive acceleration event to a remote device (e.g., cloud server 12, computer system 14, and/or mobile device 16). In some examples, acceleration monitoring application 78 issues audible alerts about an excessive acceleration event. In general, mobile device 15 records data measurements from GPS 18 and IMU 20, monitors and analyzes the data measurements with acceleration monitoring application 78, and transmits information about the data measurements to external devices via transmitter 72.

In operation, mobile device 15 receives data measurements from GPS 18 and IMU 20. In some examples, GPS 18 receives location data (e.g., latitude, longitude, and altitude) of mobile device 15 from GPS satellites over time. Mobile device 15 stores the location data in data storage 68. Acceleration monitoring application 78 analyzes the location data and determines the velocity and acceleration of mobile device 15 over time. For example, acceleration monitoring application 78 determines GPS velocity data by determining the distance traveled in a given time and dividing the distance traveled by the amount of time. Likewise, acceleration monitoring application 78 determines GPS acceleration data by determining in the change in velocity in a given time and dividing the change in velocity by the amount of time. When mobile device 15 is in vehicle 22, location data from GPS 18 corresponds not only to the location of mobile device 15, but also to the location of vehicle 22. As a result, acceleration monitoring application 78 determines the location, velocity, and acceleration of mobile device 15 and vehicle 22. Mobile device 15 stores the GPS location, velocity, and acceleration data in data storage 68. However, location data from GPS device 18 may in some cases be inaccurate or misleading. For example, mobile device 15 may lose a GPS lock if mobile device 15 is used in a tunnel or in an area surrounded by tall buildings. As a result, in some examples, acceleration monitoring application 78 is not be able to determine the velocity and acceleration of mobile device 15 and vehicle 22, or determines a velocity and acceleration that does not reflect the true velocity and acceleration. As another example, position information from GPS device 18 alone may not have a degree of precision sufficient for determining acceleration and identifying high-acceleration events.

In some examples, IMU 20 includes an accelerometer and outputs inertial measurements over time. Mobile device 15 may filter IMU acceleration data through a low pass filter to attenuate the high frequency noise of the measurements. Mobile device 15 receives the acceleration data from IMU 20 and stores the acceleration data in data storage 68. Acceleration monitoring application 78 analyzes the acceleration data from IMU 20 to determine the acceleration of mobile device 15 over time. However, in some examples, acceleration data from IMU 20 is also inaccurate or misleading. For example, if mobile device 15 is located in vehicle 22 and vehicle 22 runs over a pothole or series of bumps, or if the user manipulates the orientation of mobile device 15, IMU 20 may record acceleration measurements that are not indicative of excessive acceleration events caused by risky driving.

Acceleration monitoring application 78 compares the GPS acceleration data from to the IMU acceleration data in order to determine a more accurate representation of the vehicle acceleration. For example, acceleration monitoring application 78 determines a GPS acceleration vector based on the GPS acceleration data and determines an IMU acceleration vector based on the IMU acceleration data. Acceleration monitoring application 78 compares the GPS acceleration vector to the IMU acceleration vector to determine whether the GPS acceleration vector and the IMU acceleration vector coincide with one another.

Before comparing the GPS acceleration vector to the IMU acceleration vector, acceleration monitoring application 78 transforms one or both of the vectors to ensure that they are comparable. In some examples, the GPS acceleration vector from GPS 18 is in a different coordinate frame than the IMU acceleration vector from IMU 20. Since the GPS acceleration vector from GPS 18 is not sensitive to the orientation of mobile device, the GPS acceleration vector is in the vehicle coordinate frame. In the vehicle coordinate frame, the coordinate system of vehicle 22 defines the longitudinal and lateral axes. However, the IMU acceleration vector may be relative to a different coordinate frame. Since mobile device 15 is not necessarily stationary relative to vehicle 22 (e.g., due to a user manipulating the orientation of mobile device 15), the IMU acceleration vector is relative to mobile device 15. Mobile device 15 has its own coordinate system called the mobile device reference frame. Thus, acceleration measurements from IMU 20 (e.g., the IMU acceleration vector) are with respect to the mobile device coordinate frame.

In the mobile device coordinate frame, the IMU acceleration vector is also referred to as the “proper acceleration vector.” The proper acceleration vector includes acceleration due to gravity. In vector terms, the acceleration due to gravity is also called the gravity vector. In order to compare the proper acceleration vector to the GPS acceleration vector (which does not include the effects due to gravity), the proper acceleration vector must be transformed to remove the gravity vector. Acceleration monitoring application 78 transforms the proper acceleration vector (i.e., the IMU acceleration in the mobile device coordinate frame, including the effects of gravity) to the coordinate acceleration vector (i.e., the IMU acceleration vector without the effects of gravity) by determining a gravity vector for mobile device 15 and removing the gravity vector.

Acceleration monitoring application 78 estimates the gravity vector, in some examples, by averaging the acceleration of mobile device 15 in the mobile device coordinate reference frame when mobile device 15 is at zero, or approximately zero, velocity (i.e., when the vehicle is at rest, or nearly at rest). For example, acceleration monitoring application 78 determines whether mobile device 15 is moving by analyzing GPS velocity data, which is determined based on the GPS location data from GPS 18 as described above. If the velocity is less than a threshold velocity, acceleration monitoring application 78 computes the mean and standard deviation of the proper acceleration vector measurements.

In some examples, acceleration monitoring application 78 calculates the mean and standard deviations of the proper acceleration vector measurements over a predefined time period (e.g., the previous 1 second, 5 seconds, 60 seconds, or any predefined time period) or for a predefined number of measurements. In some examples, the number of measurements depends on the sample rate of IMU 20. For example, if the sample rate of IMU 20 is 50 Hz, acceleration monitoring application 78 determines the mean and standard deviation of the proper acceleration vector measurements every 1 second, or after 50 measurements. Acceleration monitoring application 78 compares the standard deviation of the proper acceleration vector measurements to a threshold value. If the standard deviation of the proper acceleration measurements is less than the threshold value, acceleration monitoring application 78 determines that the proper acceleration data is consistent enough to calculate the gravity vector. If the proper acceleration data is consistent (i.e., the standard deviation of the proper acceleration vector measurement are within the threshold value), acceleration monitoring application 78 calculates the gravity vector.

Acceleration monitoring application 78 determines whether the y-coordinate axis of the proper acceleration vector is aligned with the gravity vector. In some examples, acceleration monitoring application 78 determines whether the y-coordinate axis of the proper acceleration vector is aligned with the gravity vector by determining whether the absolute value of the difference between the y-component of the proper acceleration vector (abbreviated as “PAY”) and the acceleration due to gravity on earth (approximately 9.81 m/ŝ2) is greater than a threshold value (i.e., |PAY−9.81|>threshold).

In some examples, acceleration monitoring application 78 determines that the y-coordinate axis of the proper acceleration vector is not aligned with the gravity vector because the absolute value of the difference between e y-component of the proper acceleration vector and the acceleration due to gravity (i.e., |PAY−9.81|) is greater than a threshold value. As a result, acceleration monitoring application 78 determines that mobile device 15 is not fixed relative to vehicle 22 (i.e., mobile device 15 is not in a mount, glove-box, pocket, purse, or otherwise stationary with respect to vehicle 22). If acceleration monitoring application 78 determines that mobile device 15 is not fixed relative to vehicle 22, acceleration monitoring application 78 resets the bias and gravity compensation values. For example, if a user is using mobile device 15, acceleration monitoring application 78 determines that mobile device 15 is not fixed relative to vehicle 22 and that the IMU acceleration data is unreliable. Thus, acceleration monitoring application 78 determines that acceleration monitoring application 78 cannot compare the IMU acceleration data to the GPS acceleration data. As a result, acceleration monitoring application 78 discards or ignores the proper acceleration vector and resets the bias and gravity compensation values. In some examples, acceleration monitoring application 78 continues to monitor the IMU acceleration data, re-calculates the proper acceleration vector, and determines whether the y-coordinate axis of the re-calculated proper acceleration vector is aligned with the gravity vector.

However, acceleration monitoring application 78 may determine the y-axis is aligned with the gravity vector if the absolute value of the difference between the y-component of the proper acceleration vector and standard gravity (i.e., |PAY−9.81|) is less than a threshold value. If the y-coordinate axis of the proper acceleration vector is aligned with the gravity vector, acceleration monitoring application 78 subtracts the gravity vector from the proper acceleration vector to determine an estimate of the adjusted IMU acceleration vector, called the “coordinate acceleration vector”. The coordinate acceleration vector includes acceleration in the longitudinal and lateral directions but not in the vertical direction (i.e., the coordinate acceleration vector estimates the acceleration after the effects of gravity on the acceleration are removed).

By removing the gravity vector, acceleration monitoring application 78 can compare the coordinate acceleration vector to the GPS acceleration vector. Since the proper acceleration vector intrinsically includes accelerometer bias values, removing the gravity vector produces a coordinate acceleration vector that is bias compensated.

Acceleration monitoring application 78 compares the coordinate acceleration vector to the GPS acceleration vector to determine whether the acceleration measurements coincide with one another. Since the GPS acceleration vector does not depend on the orientation of mobile device 15, in some examples, the GPS acceleration vector (A_{GPS}) is used as a proxy for the acceleration of vehicle 22 (A_{vehicle}) in the vehicle coordinate frame.

In order to compare the coordinate acceleration vector and the GPS acceleration vector, acceleration monitoring application 78 estimates the lateral and longitudinal acceleration for the GPS acceleration vector and the coordinate acceleration vector.

Acceleration monitoring application 78 estimates the lateral acceleration, A_{lat,GPS,} and longitudinal acceleration, A_{long,GPS}, based on the GPS acceleration vector A_{GPS}. In some examples, the acceleration of vehicle 22 along the longitudinal axis at time T is estimated by calculating the backward finite difference of speed measurements output by GPS 18. For example, the acceleration of vehicle 22 along the longitudinal axis is be calculated from GPS data from GPS 18 using the formula:

$${A}_{long , GPS} = \frac{{V}_{T} - {V}_{T - 1}}{Δ T} \qquad Equation 1$$

where V_{T} is the speed at time T as measured by GPS 18. In some examples, the acceleration of vehicle 22 along the lateral axis at time T is estimated by using the equation for centripetal acceleration as shown below:

$${A}_{lat , GPS} = \frac{{V}_{T}^{2}}{r} \qquad Equation 2$$

where R represents the radius of the vehicle's path and is estimated using a least squares circle fit of the GPS data. For example, the latitude, longitude, and altitude measurements from the GPS may be transformed into North, East, and Down (NED) coordinate frame. The NED North and East axes form a plane that is tangent to the surface of the earth at the origin of the mobile device coordinate system.

Likewise, acceleration monitoring application 78 estimates the lateral acceleration, A_{lat,IMU}, and longitudinal acceleration, A_{long,IMU}, based on the coordinate acceleration vector. The coordinate acceleration vector is not fixed to the vehicle coordinate frame because the orientation of mobile device 15 is not fixed relative to vehicle 22. However, acceleration monitoring application 78 may be configured to assume that the magnitude of the GPS acceleration vector is equal to the magnitude of acceleration of mobile device 15 (A_{IMU}). In some examples, acceleration monitoring application 78 is configured to assume that the vehicle's acceleration in vertical direction (i.e., the axis perpendicular to both the lateral and longitudinal axes) is zero. Under these assumption, A_{IMU} is given by the following:

|A_{IMU}|²=Aₗₐₜ²+A_{long}² Equation 3:

if

A_{GPS}=±\sqrt{Aₗₐₜ²+A_{long}²} Equation 4:

Therefore, the lateral acceleration Aₗₐₜ of vehicle 22 or the longitudinal acceleration A_{long} of vehicle 22 can be determined by the respective equations:

A_{long}=±\sqrt{Aₗₐₜ²−|A_{IMU}|²} Equation 5:

Aₗₐₜ=±\sqrt{A_{long}²−|A_{IMU}|²} Equation 6:

However, the lateral acceleration A_{lat,IMU} and the longitudinal acceleration A_{long,IMU} in the vehicle coordinate frame cannot be determined solely from the acceleration data from IMU 22. Therefore, the acceleration values A_{lat,GPS} and A_{long,GPS} computed from the GPS acceleration vector may be used to solve Equations 5 and 6. Thus, in some examples, acceleration monitoring application 78 solves for the lateral acceleration A_{lat,IMU} and the longitudinal acceleration A_{long,IMU}, using the formulas below:

A_{long,IMU}=±\sqrt{A_{lat,GPS}²−|A_{IMU}|²} Equation 7:

A_{lat,IMU}=±\sqrt{A_{long,GPS}²−|A_{IMU}|²} Equation 8:

Once acceleration monitoring application 78 has determined the lateral acceleration and longitudinal acceleration for the GPS acceleration data (A_{lat,GPS} and A_{long,GPS}) and the IMU acceleration data (A_{lat,IMU} and A_{long,IMU}), acceleration monitoring application 78 compares the lateral acceleration values and/or the longitudinal acceleration values to determine whether the values are consistent with one another. In some examples, acceleration monitoring application 78 compares each lateral acceleration value to a lateral acceleration threshold value to determine whether both lateral acceleration values exceed the lateral acceleration threshold. Likewise, acceleration monitoring application 78 compares each longitudinal acceleration value to a longitudinal acceleration threshold value to determine whether both lateral acceleration values exceed the longitudinal acceleration threshold.

In some examples, acceleration monitoring application 78 is configured to compare the lateral acceleration values and the longitudinal acceleration values to determine whether an excessive acceleration event has occurred. In some examples, excessive acceleration events include excessive turning maneuvers, excessive acceleration maneuvers, and excessive braking maneuvers.

For example, acceleration monitoring application 78 is configured to determine whether an excessive turning maneuver has occurred by determining whether A_{lat,IMU} exceeds a lateral acceleration threshold and whether A_{lat,GPS} exceeds a lateral acceleration threshold value. In some examples, the lateral acceleration threshold value may be 4.5 m/ŝ2 such that acceleration monitoring application 78 determines that an excessive turning maneuver has occurred if the absolute value of both A_{lat,IMU} and A_{lat,GPS} are greater than 4.5 m/ŝ2. For example, if the lateral acceleration threshold value equal 4.5 m/ŝ2, A_{lat,IMU} equals 5.0 m/ŝ2, and A_{lat,GPS} equals 2.0 m/ŝ2, acceleration monitoring application 78 determines that the IMU acceleration data indicates an excessive lateral acceleration because A_{lat,IMU} exceeds the lateral acceleration threshold value but that the GPS acceleration data does not indicate an excessive lateral acceleration because A_{lat,GPS} does not exceed the lateral acceleration threshold value. Since the GPS acceleration data and the IMU acceleration data do not coincide, (i.e., they do not both exceed the lateral acceleration threshold value), acceleration monitoring application 78 does not record the acceleration as an excessive turning maneuver. In another example, if the lateral acceleration threshold value equal 4.5 m/ŝ2, A_{lat,IMU} equals 5.0 m/ŝ2, and A_{lat,GPS} equals 5.5 m/ŝ2, acceleration monitoring application 78 determines that the IMU acceleration data and the GPS acceleration data both indicate an excessive lateral acceleration because both acceleration values exceed the lateral acceleration threshold value. Since the GPS acceleration data and the IMU acceleration data coincide with one another, (i.e., both values exceed the lateral acceleration threshold value), acceleration monitoring application 78 records the acceleration as an excessive turning maneuver.

Acceleration monitoring application 78 is configured to determine whether an excessive acceleration maneuver has occurred by determining whether A_{long,GPS} and A_{long,IMU} exceed an acceleration threshold value. In some examples, the acceleration threshold value may be 3.5 m/ŝ2. For example, if the acceleration threshold value equals 3.5 m/ŝ2, A_{long,GPS} equals 4.5 m/ŝ2, and A_{long,IMU} equals 4.6 m/ŝ2, acceleration monitoring application 78 determines that an excessive acceleration maneuver has occurred because A_{long,GPS} and A_{long,IMU} both exceed the acceleration threshold value.

Acceleration monitoring application 78 is configured to determine whether an excessive braking maneuver has occurred by determining whether A_{long,GPS} and A_{long,IMU} exceed a braking acceleration threshold value. In some examples, the braking acceleration threshold value may be −3.0 m/ŝ2. For example, if the braking acceleration threshold value equal −3.0 m/ŝ2, A_{long,GPS} equals −4.0 m/ŝ2, and A_{long,IMU} equals −4.5 m/ŝ2, acceleration monitoring application 78 determines that an excessive breaking maneuver has occurred because A_{long,GPS} and A_{long,IMU} both exceed the braking acceleration threshold value.

While specific examples of the lateral acceleration threshold value, acceleration threshold value, and breaking acceleration threshold value are given, other values for the respective threshold values may exist. In some examples, the lateral acceleration threshold value, the acceleration threshold value, and/or braking acceleration threshold value may be predetermined. However, the acceleration threshold values may be configurable (e.g., depending on the age or skill level of the driver).

Acceleration monitoring application 78 is configured to report an excessive turning maneuver, excessive acceleration maneuver, or excessive braking maneuver. In some examples, acceleration monitoring application 78 is configured to cause GUI 79 to display a message to the driver that informs the driver the acceleration was excessive. In some examples, acceleration monitoring application 78 causes mobile device 15 to output an audible message informing the driver that the acceleration was excessive. In some examples, acceleration monitoring application 78 inform the driver what type of excessive acceleration was detected and/or the magnitude of the acceleration. Acceleration monitoring application 78 transmits information about the excessive acceleration to a remote device (e.g., cloud server 12, computer system 14, and/or mobile device 16) via transmitter 72. The transmitted information may include the type of excessive acceleration (e.g., turning, acceleration, or braking), magnitude of the excessive acceleration, and date, time, and location of the excessive acceleration. In some examples, if mobile device is used by a teenager, acceleration monitoring application 78 sends a notice to a parent's mobile device 16 via transmitter 72. As another example, information about the excessive acceleration event is sent to cloud server 12 used by the driver's insurance company to be used in rate making. In some examples, information about the excessive acceleration maneuver is be sent to computer system 14 to be used by government offices to detect roads and locations that frequently have excessive acceleration to determine dangerous sections of roads and improve safety.

In some examples, the techniques further include a computing device, such as cloud server 12, computer system 14, and/or mobile devices 15, 16, which is configured to store information about excessive acceleration events detected by acceleration monitoring application 78. In another example, a computer system is configured to execute acceleration monitoring application 78. In another example, a non-transitory computer-readable medium including instructions for causing a programmable processor to execute may execute acceleration monitoring application 78.

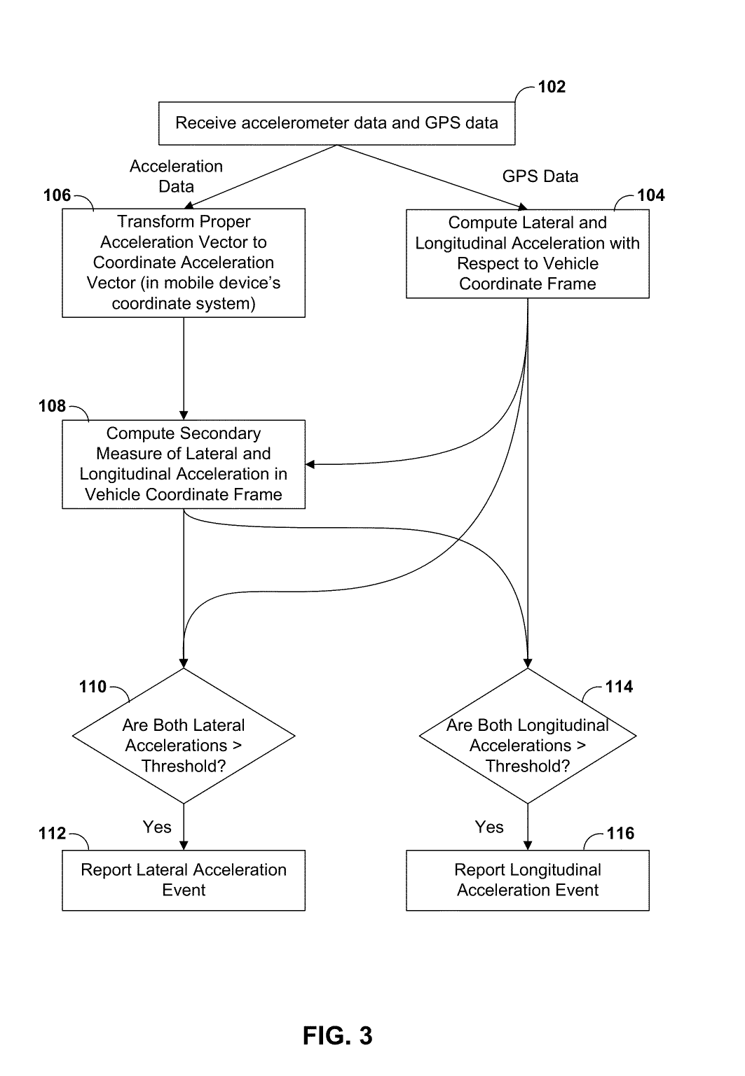

FIG. 3 is a flow diagram illustrating one example of an acceleration monitoring application implementing the techniques described herein. In the illustrated example, mobile device 15 receives accelerometer data from IMU 20 and GPS data from GPS 18 (102). Using the received GPS data, acceleration monitor application 78 determines the lateral acceleration and longitudinal acceleration of mobile device 15 with respect to the vehicle coordinate frame (104). Because the GPS data does not depend on the orientation of mobile device 15, the lateral acceleration and longitudinal acceleration that are calculated using GPS data are indicative of the lateral and longitudinal acceleration of vehicle 22. Using the acceleration data, acceleration monitor application 78 determines a proper acceleration vector of mobile device 15 with respect to the mobile device reference frame. Acceleration monitoring application 78 transforms a proper acceleration vector to a coordinate acceleration vector (106) by removing the gravity vector from the proper acceleration vector. Acceleration monitoring application 78 determines a secondary measure of the lateral acceleration and longitudinal acceleration of mobile device 15 in the vehicle coordinate frame (108). The secondary lateral acceleration and longitudinal acceleration are calculated based on the coordinate acceleration vector and the assumption that the magnitude of the GPS acceleration and the magnitude of the IMU acceleration are equal.

Acceleration monitoring application 78 determines whether an excessive lateral acceleration event has occurred and whether an excessive longitudinal acceleration event has occurred. Acceleration monitoring application 78 determines whether both the lateral acceleration based on the GPS data and the lateral acceleration based on the acceleration data are greater than a lateral acceleration threshold value (110). If both lateral accelerations are greater than the lateral acceleration threshold value, acceleration monitoring application determines that an excessive lateral acceleration event has occurred and reports an excessive turning maneuver (112). By comparing the latitudinal acceleration from the GPS data and the secondary latitudinal acceleration to the lateral acceleration threshold value, acceleration monitoring application 78 may more accurately determine whether an excessive turning maneuver has occurred.

Acceleration monitoring application 78 determines whether both the longitudinal acceleration based on the GPS data and the longitudinal acceleration based on the acceleration data are greater than a longitudinal acceleration threshold value (114). If both longitudinal accelerations are greater than the longitudinal acceleration threshold value, acceleration monitoring application determines that an excessive longitudinal acceleration event has occurred and reports either an excessive acceleration maneuver or an excessive braking maneuver (116). By comparing the longitudinal acceleration from the GPS data and the secondary longitudinal acceleration to the longitudinal acceleration threshold value, acceleration monitoring application 78 may more accurately determine whether an excessive acceleration event (e.g., an excessive acceleration maneuver or an excessive braking maneuver) has occurred.

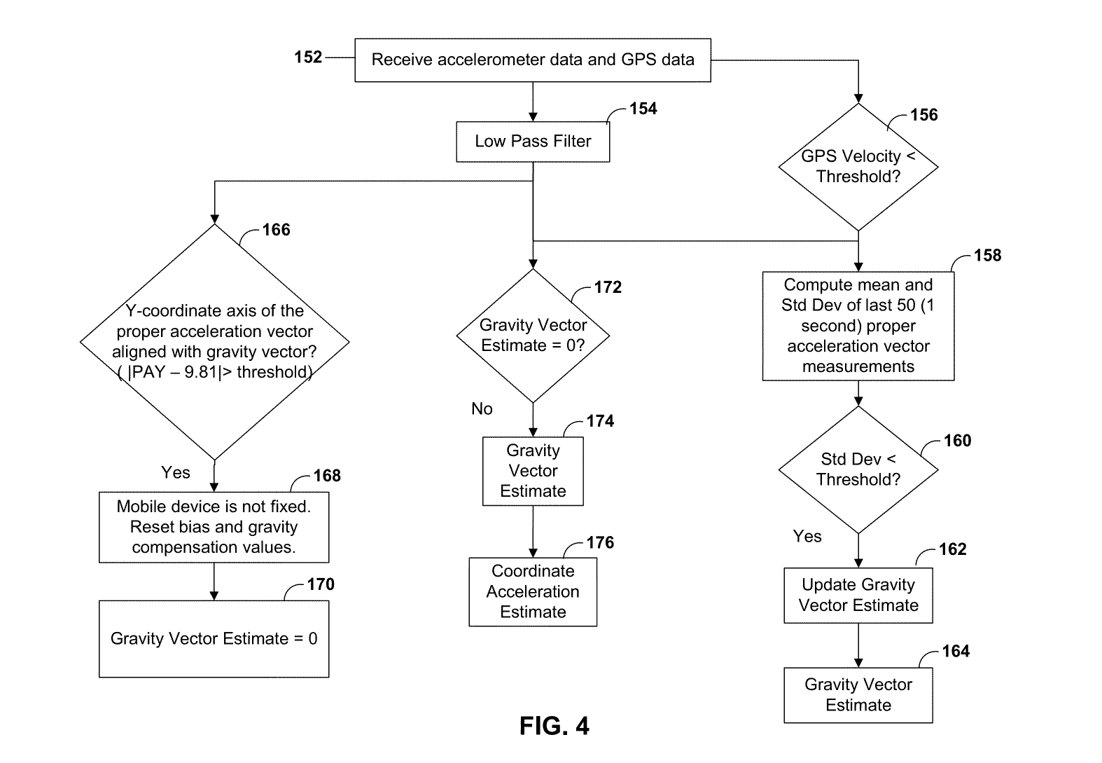

FIG. 4 is a flow diagram illustrating one example of an acceleration monitoring application implementing the techniques described herein. In the illustrated example, mobile device 15 receives accelerometer data from IMU 20 and GPS data from GPS 18 (152). Mobile device 15 filters the accelerometer data using a low pass filter (154). Acceleration monitoring application 78 calculates a GPS velocity over time using the GPS location data and dividing the change in location over a given time period by the amount of time in the given time period. Acceleration monitoring application 78 determines whether the GPS velocity is less than a threshold velocity (156). If the GPS velocity is less than the threshold velocity, acceleration monitoring application 78 determines the mean and standard deviation of the proper acceleration vector over a particular time period (e.g., the previous second, or if IMU 20 has a 50 Hz sample rate, the previous 50 measurements) (158). Acceleration monitoring application 78 determines whether the standard deviation of the proper acceleration vector is less than a standard deviation threshold (160). If the standard deviation of the proper acceleration vector is less than the standard deviation threshold, acceleration monitoring application updates the gravity vector estimate (162) based on the mean of the proper acceleration vector.

Acceleration monitoring application 78 determines whether the y-coordinate axis of the proper acceleration vector is aligned with the gravity vector (166). Acceleration monitoring application 78 determines whether the proper acceleration vector is aligned with the gravity vector by determining whether the absolute value of the difference between the y-component of the proper acceleration vector and the acceleration due to gravity (i.e., |PAY−9.81|) is greater than a threshold value. If the absolute value of the difference between the y-component of the proper acceleration vector and the acceleration due to gravity is greater than the threshold, acceleration monitoring application determines that the y-coordinate axis of the proper acceleration vector is not aligned with the gravity vector. In other words, acceleration monitoring application 78 determines that mobile device 15 is not fixed relative to vehicle 22 (e.g., mobile device 15 is not in a mount, pocket, purse, or otherwise fixed). As a result, acceleration monitoring application 78 discards or ignores the proper acceleration vector, and resets the bias and gravity compensation values (168). Acceleration monitoring application 78 sets the gravity vector 78 equal to zero (170).

If the absolute value of the difference between the y-component of the proper acceleration vector and the acceleration due to gravity is less than or equal to the threshold, acceleration monitoring application determines that the y-coordinate axis of the proper acceleration vector is aligned with the gravity vector. In other words, acceleration monitoring application 78 determines that mobile device 15 is fixed relative to vehicle 22.

Acceleration monitoring application determines whether the gravity vector estimate is equal to zero (172). If the gravity vector does not equal zero, acceleration monitoring application 78 estimates the coordinate acceleration vector (176) by removing the gravity vector from the proper acceleration vector. By calculating and removing the gravity vector, acceleration monitoring application 78 compare the GPS acceleration data to the IMU acceleration data to more accurately determine whether an excessive acceleration event has occurred.

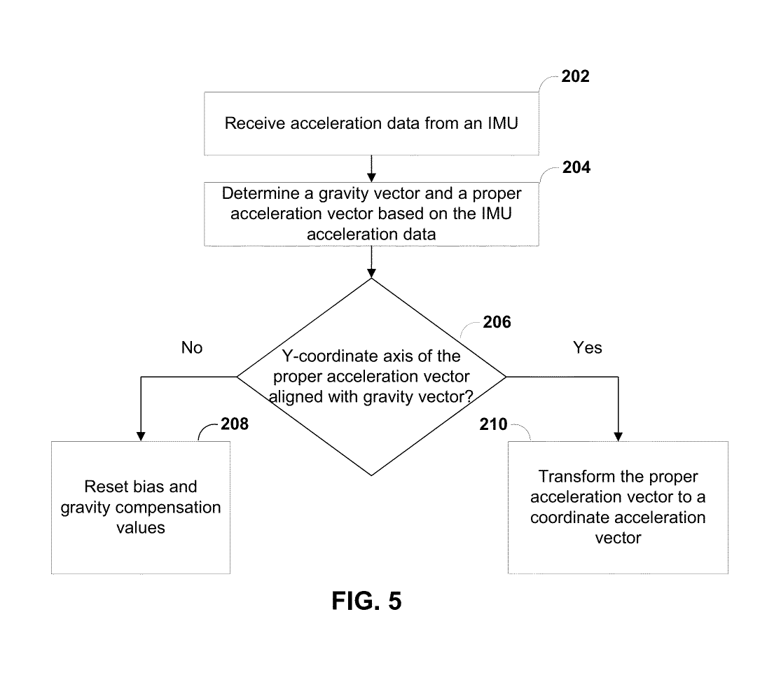

FIG. 5 is a flow diagram illustrating one example of an acceleration monitoring application implementing the techniques described herein. In the illustrated example, mobile device 15 receives acceleration data from IMU 20 (202). Mobile device 15 determines a gravity vector and a proper acceleration vector based on the received IMU acceleration data (204). Mobile device 15 determines whether the y-coordinate axis of the proper acceleration vector is aligned with the gravity vector (206). Mobile device 15 determines whether the y-coordinate axis of the proper acceleration vector is aligned with the gravity by determining whether the absolute value of the difference between the y-component of the proper acceleration vector and the acceleration due to gravity (i.e., |PAY−9.81|) is greater than a threshold value. If the y-coordinate axis of the proper acceleration vector is not aligned with the gravity vector, mobile device 15 determines that mobile device 15 is not in stationary with respect to vehicle 22 (e.g., mobile device 15 is not in a mount, pocket, purse, or otherwise not moving with respect to vehicle 22). As a result, mobile device 15 determines not to use the acceleration data and resets the bias and gravity compensation values (208). If the y-coordinate axis of the proper acceleration vector is aligned with the gravity vector, mobile device 15 transforms the proper vector to a coordinate acceleration vector (210). Mobile device 15 transforms the proper acceleration vector to a coordinate acceleration vector by removing the gravity vector from the proper acceleration vector.

The techniques described in this disclosure may be implemented, at least in part, in hardware, software, firmware, or any combination thereof. For example, various aspects of the described techniques, including the disclosed mobile device 15, 16, cloud 12, and/or computer system 14, are implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, in some examples, functionality associated with one or more modules or units is performed by separate hardware, firmware, or software components, or integrated within common or separate hardware, firmware, or software components.

In some examples, the techniques described in this disclosure are also be embodied or encoded in a computer-readable medium, such as a transitory or non-transitory computer-readable storage medium, containing instructions. Instructions embedded or encoded in a computer-readable medium, including a computer-readable storage medium, cause one or more programmable processors, or other processors, such one or more processors included in a control system, to implement one or more of the techniques described herein, such as when instructions included or encoded in the computer-readable medium are executed by the one or more processors. Non-transitory computer-readable storage media includes random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer-readable media. In some examples, an article of manufacture comprises one or more computer-readable storage media.

Various embodiments of the invention have been described. These and other embodiments are within the scope of the following claims.

What is claimed is:

1. A method comprising:
receiving, from an accelerometer in a mobile device within a vehicle, a first acceleration data when the vehicle is at rest and a second acceleration data when the vehicle is moving;
determining, based on the first acceleration data, a gravity vector;
determining, based on the second acceleration data, an acceleration vector for the mobile device; and
responsive to determining that a y-coordinate axis of the acceleration vector for the mobile device is aligned with the gravity vector:
updating the acceleration vector by removing the gravity vector from the acceleration vector for the mobile device; and
processing the updated acceleration vector to identify an excessive acceleration event for the vehicle.

2. The method of claim 1, wherein determining the gravity vector includes averaging the first acceleration data received over a time period while the vehicle is determined to be at rest and prior to the vehicle commencing movement.

3. The method of claim 1, wherein determining that the y-coordinate axis of the acceleration vector for the mobile device is aligned with the gravity vector includes determining that the absolute value of the difference between the y-component of the acceleration vector and the gravity vector is less than a threshold value.

4. The method of claim 1, further comprising:
receiving, from a GPS in the mobile device, GPS data;
determining, based on the GPS data, a velocity of the mobile device; and
determining whether the velocity of the mobile device is less than a threshold velocity; and
determining, based on the first acceleration data, the gravity vector only when the velocity of the mobile device is less than the threshold velocity.

5. The method of claim 1, further comprising:
responsive to determining that the y-coordinate axis of the acceleration vector for the mobile device is not aligned with the gravity vector, discarding the acceleration vector for the mobile device without processing the updated acceleration vector to identify the excessive acceleration event.

6. The method of claim 5, further comprising:
monitoring subsequent acceleration data from the accelerometer until the y-coordinate axis of the acceleration vector for the mobile device is re-aligned with the gravity vector; and
responsive to determining that the acceleration vector for the mobile device is re-aligned with the gravity vector, processing the subsequent acceleration data to remove the gravity vector and identify any excessive acceleration event for the vehicle

7. The method of claim 1, further comprising:
receiving, from a GPS in the mobile device, GPS data;
determining, based on the GPS data, a lateral acceleration;
determining, based on the acceleration vector for the mobile device, a lateral acceleration for the mobile device; and
identifying the excessive acceleration event responsive to determining that both the lateral acceleration determined from the GPS data and the lateral acceleration determined from the second acceleration data for the mobile device satisfy a threshold.

8. The method of claim 1, the method further comprising:
receiving, from a GPS in the mobile device, GPS data;
determining, based on the GPS data, a longitudinal acceleration;
determining, based on the acceleration vector for the mobile device, a longitudinal acceleration for the mobile device; and
identifying the excessive acceleration event responsive to determining that both the longitudinal acceleration determined from the GPS data and the longitudinal acceleration determined from the second acceleration data for the mobile device satisfy a threshold

9. The method of claim 8, wherein the excessive acceleration event comprises an excessive acceleration maneuver or an excessive braking maneuver.

10. A mobile device comprising:
an accelerometer;
a global positioning system (GPS) sensor;
a processor configured to identify an excessive acceleration event of a vehicle that the mobile device is located in, by:
receiving, from the accelerometer, a first acceleration data when the vehicle is at rest and a second acceleration data when the vehicle is moving;
determining, based on the first acceleration data, a gravity vector;
determining, based on the second acceleration data, an acceleration vector for the mobile device; and
responsive to determining that a y-coordinate axis of the acceleration vector for the mobile device is aligned with the gravity vector:
updating the acceleration vector by removing the gravity vector from the acceleration vector for the mobile device; and
processing the updated acceleration vector to identify the excessive acceleration event for the vehicle.

11. The mobile device of claim 10, wherein determining the gravity vector includes averaging the first acceleration data received over a time period while the vehicle is determined to be at rest and prior to the vehicle commencing movement.

12. The mobile device of claim 10, wherein the processor is configured to determine that the y-coordinate axis is aligned with the gravity vector by at least determining that the absolute value of the difference between the y-component of the acceleration vector and the gravity vector is less than threshold value.

13. The mobile device of claim 10, wherein the processor is further configured to:
receive, from the GPS sensor, GPS data;
determine, based on the GPS data, a velocity of the mobile device;
determine whether the velocity of the mobile device is less than a threshold velocity; and
determine, based on the first acceleration data, the gravity vector only when the velocity of the mobile device is less than the threshold velocity.

14. The mobile device of claim 10, wherein the processor is further configured to:
responsive to determining that the y-coordinate axis of the acceleration vector for the mobile device is not aligned with the gravity vector, discard the acceleration vector for the mobile device without processing the updated acceleration vector to identify the excessive acceleration event.

15. The mobile device of claim 14, wherein the processor is further configured to:
monitor subsequent acceleration data from the accelerometer until the y-coordinate axis of the acceleration vector for the mobile device is re-aligned with the gravity vector; and
responsive to determining that the acceleration vector for the mobile device is re-aligned with the gravity vector, process the subsequent acceleration data to remove the gravity vector and identify any excessive acceleration event for the vehicle.

16. The mobile device of claim 10, wherein the processor is further configured to:
receive, from the GPS sensor, GPS data;
determine, based on the GPS data, a lateral acceleration;
determine, based on the acceleration vector for the mobile device, a lateral acceleration for the mobile device; and
identifying the excessive acceleration event responsive to determining that both the lateral acceleration determined from the GPS data and the lateral acceleration determined from the second acceleration data for the mobile device satisfy a threshold.

17. The mobile device of claim 10, wherein the processor is further configured to:
receive, from the GPS sensor, GPS data;
determine, based on the GPS data, a longitudinal acceleration;
determine, based on the acceleration vector for the mobile device, a longitudinal acceleration for the mobile device; and
identify the excessive acceleration event responsive to determining that both the longitudinal acceleration determined from the GPS data and the longitudinal acceleration determined from the second acceleration data for the mobile device satisfy a threshold.

18. The mobile device of claim 17, wherein the excessive acceleration event comprises an excessive acceleration maneuver or an excessive braking maneuver.
